(19) United States
(12) Patent Application Publication
(10) Pub. No.: US 2018/0029281 A1
(43) Pub. Date: Feb. 1, 2018

(54) Process of manufacturing hollow products

(71) Applicant: Cheng Kuan Wu, Lianyungang City (CN)

(72) Inventor: Cheng Kuan Wu, Lianyungang City (CN)

(21) Appl. No.: 15/726,406

(22) Filed: Oct. 6, 2017

(51) Int. Cl. B29C 49/06; B29C 39/36; B29C 35/02; B29C 71/02

(52) U.S. Cl. CPC B29C 49/063; B29C 71/02; B29C 39/36; B29C 35/0233; B29C 2049/4841

(57) ABSTRACT

A manufacturing process includes (1) disposing a platform in a first tank filled with a first liquid; (2) curing the first liquid to form a portion of a mold on the platform; (3) disposing the platform from the first tank to a second tank filled with a cleaning agent; (4) cleaning; (5) disposing the platform from the second tank to a third tank filled with a second liquid; (6) curing the second liquid to form inner and outer supports of the mold; (7) disposing the platform from the third tank to the second tank; (8) cleaning; (9) disposing the platform from the second tank to the first tank; (10) curing the first liquid to form another portion on the mold; (11) repeating steps (3) to (10) until a complete mold is created; (12) heating the mold to cause the molten material to exit, and (13) creating a hollow product.

### BACKGROUND OF THE INVENTION

### 1. Field of the Invention

The invention relates to manufacturing processes and more particularly to a process of manufacturing hollow products.

### 2. Description of Related Art

Conventional processes of manufacturing hollow products are disadvantageous because it is difficult of removing supports in the mold after finishing the product.

Thus, the need for improvement still exists.

### SUMMARY OF THE INVENTION

It is therefore one object of the invention to provide a process of manufacturing a hollow product comprising the steps of activating both a rotational device and a lifting device to dispose a platform in a first tank filled with a first liquid; activating a light curing device to cure a portion of the first liquid so that a portion of a mold is formed on the platform; activating both the lifting device and the rotational device to dispose the platform and the unfinished mold from the first tank to a second tank filled with a cleaning agent; cleaning the platform and the unfinished mold; activating both the lifting device and the rotational device to dispose the platform and the unfinished mold from the second tank to a third tank filled with a second liquid different from the first liquid; activating the light curing device to cure a portion of the second liquid to form a plurality of inner supports in the unfinished mold and a plurality of outer supports on the unfinished mold respectively; activating both the lifting device and the rotational device to dispose the platform and the unfinished mold from the third tank to the second tank; cleaning the platform and the unfinished mold including the inner supports and the outer supports in the second tank; activating both the lifting device and the rotational device to dispose the platform and the unfinished mold including the inner supports and the outer supports from the second tank to the first tank; activating the light curing device to cure a portion of the first liquid to form on the unfinished mold; repeating steps 3 to 10 until a complete mold is created; activating both the lifting device and the rotational device to dispose the platform and the finished mold including the inner supports and the outer supports from the first tank to the second tank; cleaning the platform and the finished mold in the second tank; activating both the lifting device and the rotational device to dispose the platform and the finished mold including the inner supports and the outer supports from the second tank to a fourth tank; activating the light curing device to further cure the finished mold including the inner supports and the outer supports; activating both the lifting device and the rotational device to dispose the platform and the finished mold including the inner supports and the outer supports from the fourth tank to an oven; activating the oven to heat the finished mold including the inner supports and the outer supports to melt the inner supports and the outer supports, cause the molten material to exit the mold via an opening of the mold, and create a hollow product; and activating both the lifting device and the rotational device to remove the hollow product out of the oven.

The above and other objects, features and advantages of the invention will become apparent from the following detailed description taken with the accompanying drawings.

### BRIEF DESCRIPTION OF THE DRAWINGS

FIG. 1 is a flow chart of a process of manufacturing hollow products according to the invention;

FIG. 2 is a longitudinal sectional view of a mold in an initial phase of the process;

FIG. 3 is a longitudinal sectional view of a mold in a final phase of the process;

FIG. 4 is a top view schematically showing an apparatus tied to the process; and

FIG. 5 is a side elevation of FIG. 4.

### DETAILED DESCRIPTION OF THE INVENTION

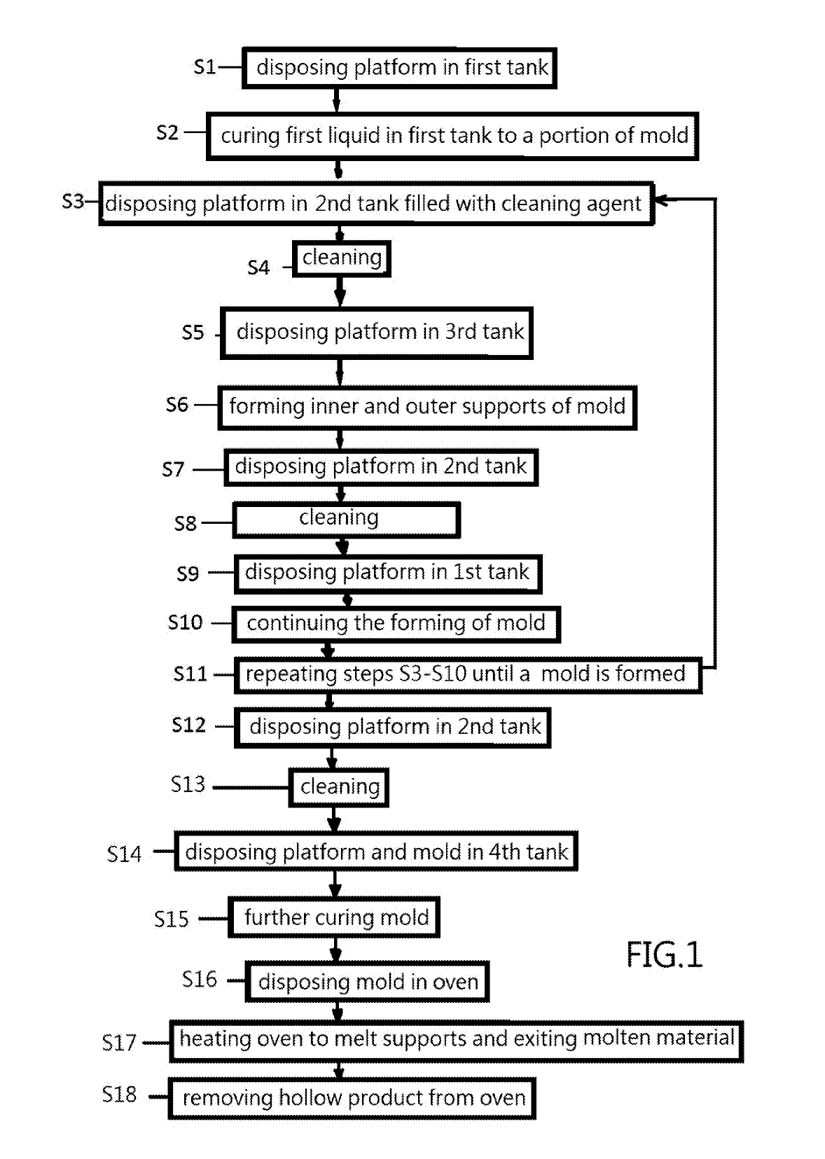

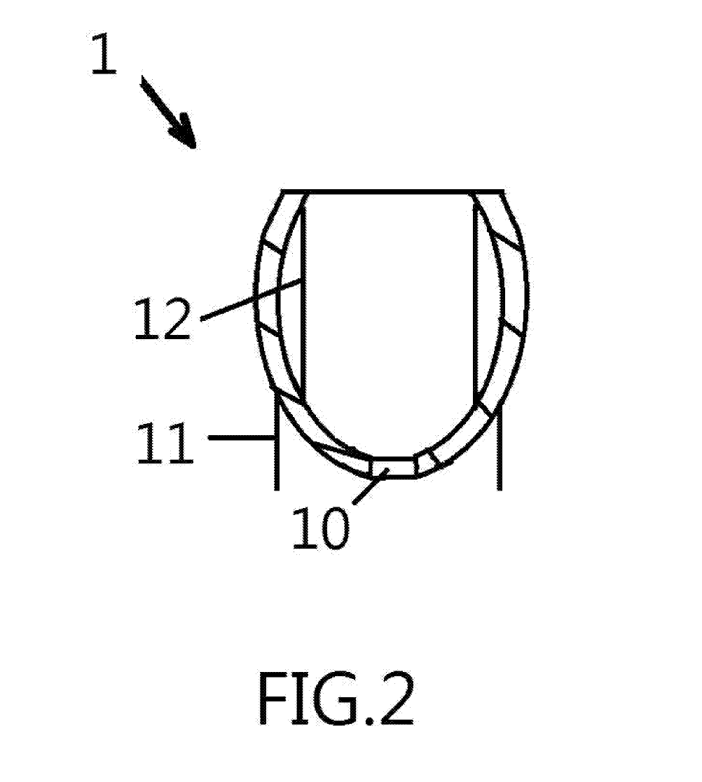

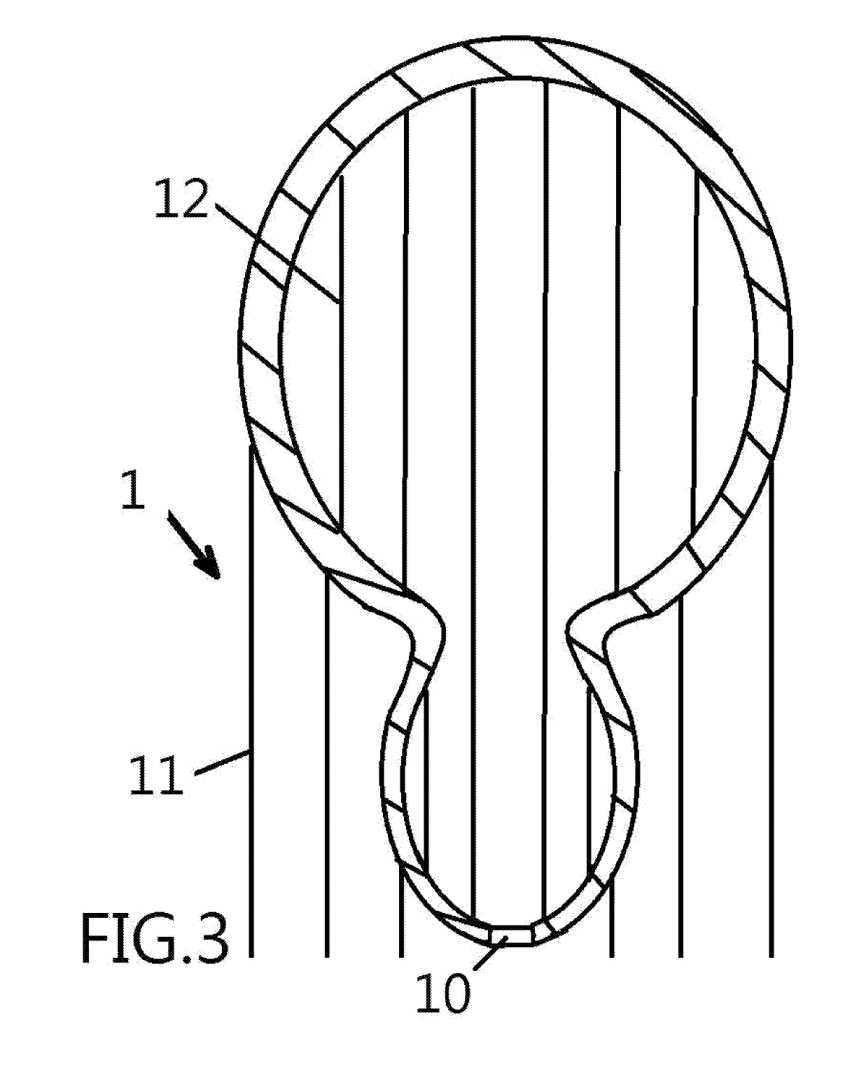

Referring to FIGS. 1 to 5, a process of manufacturing hollow products in accordance with the invention is illustrated and comprises the following steps:

Step S1: activating both a rotational device 30 and a lifting device 31 to dispose a platform 32 in a first tank 20 which contains a first liquid (e.g., liquefied ceramic).

Step S2: activating a light curing device 4 to cure a portion of the first liquid so that a portion of mold 1 can be formed on a top surface of the platform 32. In another embodiment, the mold 1 is formed on an underside of the platform 32.

Step S3: activating the lifting device 31 and the rotational device 30 to dispose the platform 32 and the unfinished mold 1 from the first tank 20 to a second tank 21 which contains a cleaning agent.

Step S4: cleaning the platform 32 and the unfinished mold 1.

Step S5: activating the lifting device 31 and the rotational device 30 to dispose the platform 32 and the unfinished mold 1 from the second tank 21 to a third tank 22 which contains a second liquid (e.g., liquefied material capable of being cured by impinging light thereon and having a melting point much less than that of the first liquid).

Step S6: activating the light curing device 4 to cure a portion of the second liquid so that a plurality of inner supports 12 are formed in the unfinished mold 1 and a plurality of outer supports 11 are formed on the unfinished mold 1 respectively.

Step S7: activating the lifting device 31 and the rotational device 30 to dispose the platform 32 and the unfinished mold 1 from the third tank 22 to the second tank 21.

Step S8: cleaning the platform 32 and the unfinished mold 1 including the inner supports 12 and the outer supports 11.

Step S9: activating the lifting device 31 and the rotational device 30 to dispose the platform 32 and the unfinished mold 1 including the inner supports 12 and the outer supports 11 from the second tank 21 to the first tank 20.

Step S10: activating the light curing device 4 to cure a portion of the first liquid to form on the unfinished mold 1.

Step S11: repeating steps S3 to S10 until a complete mold 1 is created.

Step S12: activating the lifting device 31 and the rotational device 30 to dispose the platform 32 and the finished mold 1 including the inner supports 12 and the outer supports 11 from the first tank 20 to the second tank 21.

Step S13: cleaning the platform 32 and the finished mold 1.

Step S14: activating the lifting device 31 and the rotational device 30 to dispose the platform 32 and the finished mold 1 including the inner supports 12 and the outer supports 11 from the second tank 21 to a fourth tank 23.

Step S15: activating the light curing device 4 to further cure the finished mold 1 including the inner supports 12 and the outer supports 11.

Step S16: activating the lifting device 31 and the rotational device 30 to dispose the platform 32 and the finished mold 1 including the inner supports 12 and the outer supports 11 from the fourth tank 23 to an oven 6.

Step S17: activating the oven 6 to heat the finished mold 1 including the inner supports 12 and the outer supports 11 to melt the inner supports 12 and the outer supports 11 only because both the inner support 12 and the outer support 11 have a melting point much less than that of the mold 1 which is formed of the cured first liquid. The molten material exits the mold 1 via an opening 10 of the mold 1. As a result, a hollow product 5 is created.

Step S18: activating the lifting device 31 and the rotational device 30 to remove the hollow product 5 out of the oven 6.

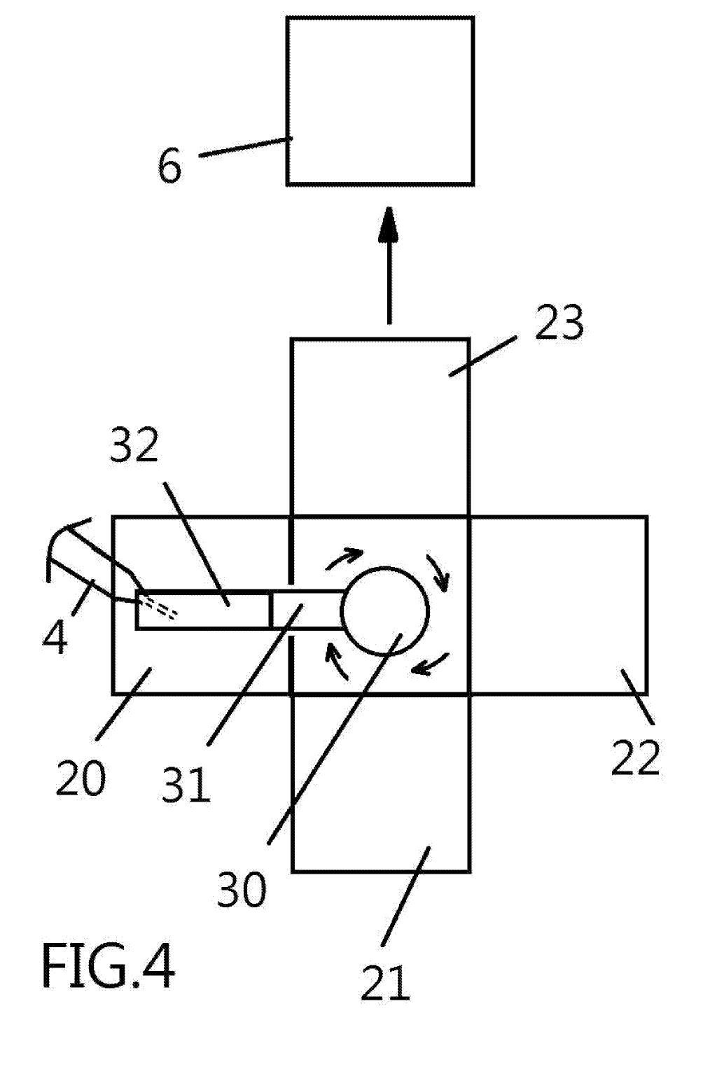

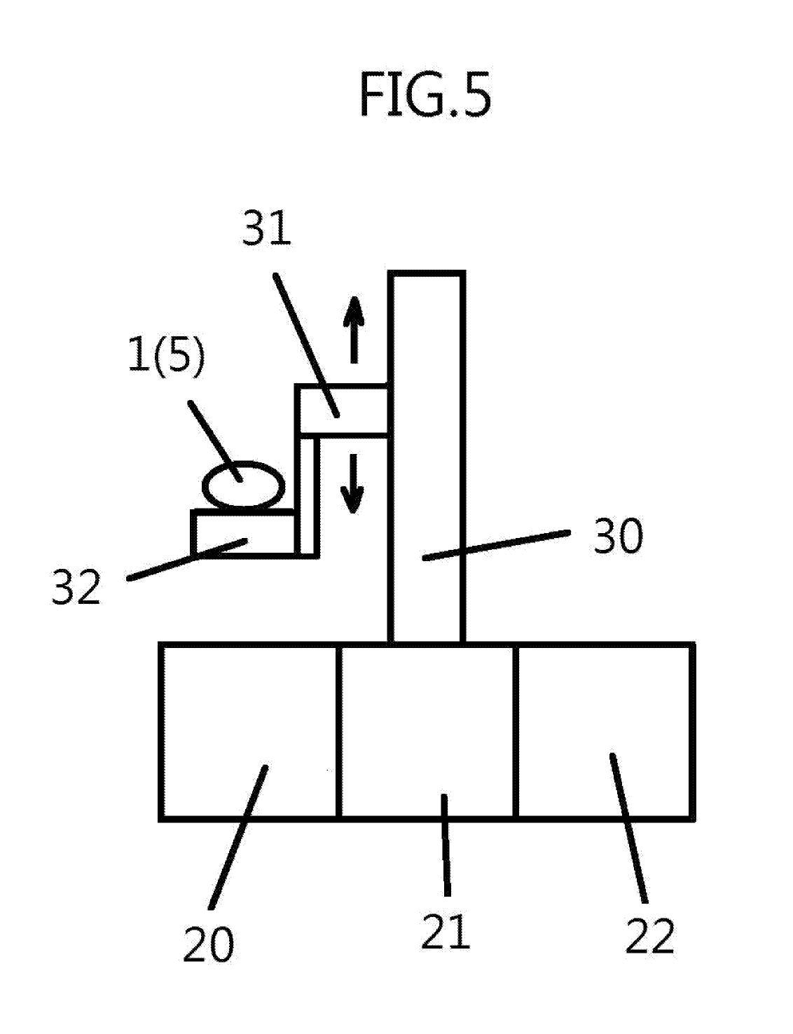

As shown in FIGS. 4 and 5 specifically, the first, second, third and fourth tanks 20, 21, 22 and 23 are arranged as a circle and the rotational device 30 is located at a center of the circle. The rotational device 30 is capable of rotating about its longitudinal axis (see four arrows). In another embodiment, the rotational device 30 is located externally of the circle and is capable of further moving on a plane (i.e., along X and Y axes).

The lifting device 31 extends out of the rotational device 30 and is capable of lifting or lowering relative to the rotational device 30. The platform 32 is disposed at an end of the lifting device 31 and is capable of lifting or lowering relative to the rotational device 30 as the lifting device 31 so as to either leave the first tank 20, the second tank 21, the third tank 22 or the fourth tank 23 or enter same. The light curing device 4 is capable of disposing in a position proximate the mold 1 to cure the first liquid, the second liquid, or the finished mold 1 including the inner supports 12 and the outer supports 11. In another embodiment, the number of the tanks 4 is greater than 4 if the first liquid is a liquefied composite material or a hollow product having more than one color is to be created in which each tank is for the creation of a portion of the mold having a single color.

While the invention has been described in terms of preferred embodiments, those skilled in the art will recognize that the invention can be practiced with modifications within the spirit and scope of the appended claims.

What is claimed is:

1. A process of manufacturing a hollow product comprising the steps of:
(1) activating both a rotational device and a lifting device to dispose a platform in a first tank filled with a first liquid;
(2) activating a light curing device to cure a portion of the first liquid so that a portion of a mold is formed on the platform;
(3) activating both the lifting device and the rotational device to dispose the platform and the unfinished mold from the first tank to a second tank filled with a cleaning agent;
(4) cleaning the platform and the unfinished mold;
(5) activating both the lifting device and the rotational device to dispose the platform and the unfinished mold from the second tank to a third tank filled with a second liquid different from the first liquid;
(6) activating the light curing device to cure a portion of the second liquid to form a plurality of inner supports in the unfinished mold and a plurality of outer supports on the unfinished mold respectively;
(7) activating both the lifting device and the rotational device to dispose the platform and the unfinished mold from the third tank to the second tank;
(8) cleaning the platform and the unfinished mold including the inner supports and the outer supports in the second tank;
(9) activating both the lifting device and the rotational device to dispose the platform and the unfinished mold including the inner supports and the outer supports from the second tank to the first tank;
(10) activating the light curing device to cure a portion of the first liquid to form on the unfinished mold;
(11) repeating steps (3) to (10) until a complete mold is created;
(12) activating both the lifting device and the rotational device to dispose the platform and the finished mold including the inner supports and the outer supports from the first tank to the second tank;
(13) cleaning the platform and the finished mold in the second tank;
(14) activating both the lifting device and the rotational device to dispose the platform and the finished mold including the inner supports and the outer supports from the second tank to a fourth tank;
(15) activating the light curing device to further cure the finished mold including the inner supports and the outer supports;
(16) activating both the lifting device and the rotational device to dispose the platform and the finished mold including the inner supports and the outer supports from the fourth tank to an oven;
(17) activating the oven to heat the finished mold including the inner supports and the outer supports to melt the inner supports and the outer supports, cause the molten material to exit the mold via an opening of the mold, and create a hollow product; and
(18) activating both the lifting device and the rotational device to remove the hollow product out of the oven.
